(19) United States
(12) Patent Application Publication
(10) Pub. No.: US 2009/0222843 A1
(43) Pub. Date: Sep. 3, 2009

(54) AUTOMATIC COMMAND STATISTIC SYSTEM AND METHOD

(75) Inventors: Yang Hu, Shenzhen City (CN); Teng-Chiao Shen, Tu-Cheng (TW); Yun-Feng Zhang, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/247,999

(22) Filed: Oct. 8, 2008

(30) Foreign Application Priority Data
Feb. 29, 2008 (CN) 200810300429.7

(51) Int. Cl. G06F 9/54

(52) U.S. Cl. 719/330

(57) ABSTRACT

An automatic command statistic system includes a detecting module, a determining module, and a recording module. The detecting module detects a command called by a user of an application and one or more calling associations of the called command. The determining module determines if the called command falls into a statistic pool that contains all commands of the application that need to be recorded. The recording module records one or more statistics regarding a command run count and calling associations of the called command that falls into the statistic pool. An automatic command statistic method is also provided.

### BACKGROUND

1. Field of the Invention

Embodiments of the present disclosure relate to computer software, and more particularly to a system and method for recording software command statistics.

2. Description of Related Art

With developments in computer software, most applications provide a command customizing function. A User of such an application can update original commands and develop new commands for the application via the command customizing function to better meet requirements of the user. Subsequently, more commands are increasingly needed, thereby making the application more difficult to use, particularly for beginners.

Such an application usually contains commands that are commonly used, making it convenient for users to learn and apply. In addition, the user of the application also needs to update the commands of the application according to a command run count, which represents the number of times a command has been called. However, statistics of the command run count of the application is usually manually recorded, which is very time-consuming and expensive, especially since the results are prone to errors.

### SUMMARY

An automatic command statistic system includes a detecting module, a determining module, and a recording module. The detecting module is configured for detecting a command that is called by a user of an application and one or more calling associations of the called command. The determining module is configured for determining if the called command falls into a statistic pool that contains all commands of the application that need to be recorded. The recording module is configured for recording one or more statistics regarding a command run count and calling associations of the called command that falls into the statistic pool.

Other advantages and novel features of the present disclosure will be drawn from the following detailed description, in which:

### BRIEF DESCRIPTION OF THE DRAWINGS

FIG. 1 is a schematic diagram of one embodiment of an application environment and functional modules of an automatic command statistic system in accordance with the present disclosure;

FIG. 2 is a flowchart of one embodiment of an automatic command statistic method in accordance with the present disclosure;

FIG. 3 is a detailed flowchart of the automatic command statistic method of FIG. 2; and

FIG. 4 is another detailed flowchart of the automatic command statistic method of FIG. 2.

### DETAILED DESCRIPTION OF CERTAIN INVENTIVE EMBODIMENTS

As used herein, the term, “called command” defines execution of one or more software commands in order to perform a selected operations. For example, a command to draw circle may be defined as a called command when executed by a user. Other commands, depending on the embodiment, may also be defined.

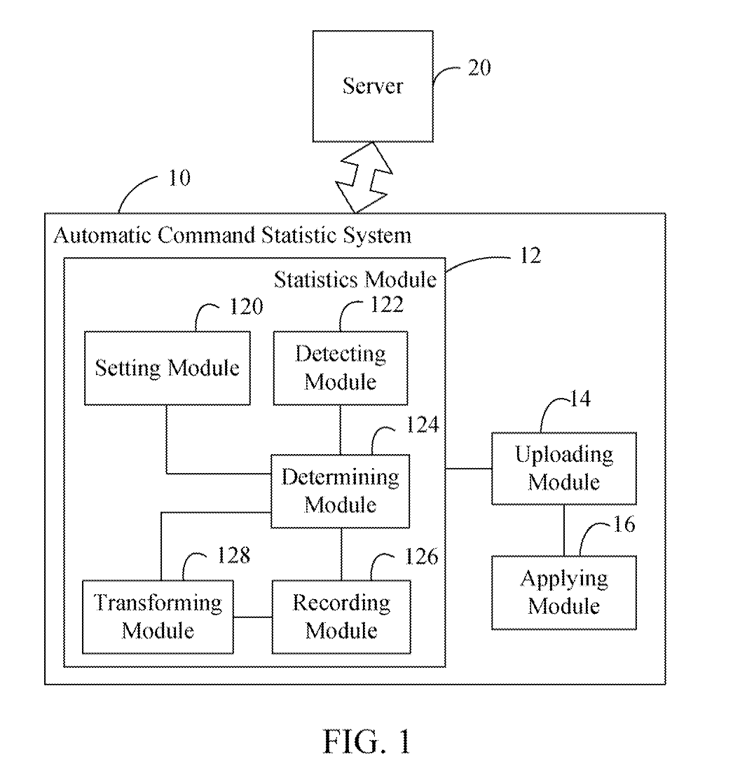

FIG. 1 is a schematic diagram of one embodiment of an application environment and functional modules of an automatic command statistic system 10 in accordance with the present disclosure. A large application usually has a large number of commands and may provide a command customizing function to develop additional commands using several development tools by users of the large application. The automatic command statistic system 10 is configured for automatically recording one or more statistics regarding a number of times a specific command has been called, known as a command run count. For example, in a predetermined time period, a user may use a command ten times while another user may use the command thirty times. Thus, the automatic command statistic system 10 records statistics for the ten times or the thirty times in every user's computer.

The automatic command statistic system 10 is further configured for automatically recording calling associations of the specific command. The calling associations represent relative information of the commands. In one embodiment, the calling associations may include information pertaining to the applications and an operating system used for operating the applications.

In one embodiment, the automatic command statistic system 10 includes a statistics module 12, an uploading module 14, and an applying module 16. The statistics module 12 includes a detecting module 122, a determining module 124, and a recording module 126. In one embodiment, the automatic command statistic system 10 automatically records one or more statistics regarding a command run count and calling association of one or more commands of a computer aided design (CAD) application.

The detecting module 122 is configured for detecting a command called by a user of the CAD application, along with the calling associations of the called command.

The determining module 124 is configured for determining if the called command falls into a statistic pool. The statistic pool contains all commands that need to be recorded. For example, a called command detected by the detecting module 122 may be called by the user of the CAD application or be called by the CAD application itself. In one embodiment, the automatic command statistic system 10 only needs to record statistics of commands that have been called by the user of the CAD application. As a result, the statistic pool contains all commands called by the user of the CAD application.

The recording module 126 is configured for recording one or more statistics regarding a command run count and calling associations of the called command that falls into the statistic pool.

In one embodiment, the statistics module 12 further includes a setting module 120 and a transforming module 128.

In the embodiment, the determining module 124 is further configured for determining a type of a called command. In one embodiment, a called command detected by the detecting module 122 may be divided into a plurality of types according to development tools. As used herein, the development tools are applications or languages for the user to develop commands for an application. For example, the user of the CAD application often uses the ObjectARX language and the list processor (LISP) language to develop commands for the CAD application. As a result, the called command detected by the detecting module 124 of the CAD application may be divided into two types. One type may be developed with the ObjectARX language. Another type may be developed with the LISP language. In one embodiment, the determining module 124 determines whether the called command detected by the detecting module 122 is developed with the ObjectARX language or the LISP language.

The setting module 120 is configured for setting a command list. In one embodiment, the command list contains all commands developed by the user of the CAD application via its command customizing function. In one embodiment, the user of the CAD application may predetermine the command list.

In one embodiment, the determining module 124 is further configured for determining if the command list includes the called command developed with the ObjectARX language. Specifically, if the determining module 124 determines the called command has been developed with the ObjectARX language, the determining module 124 then matches the called command with the command list so as to determine if the command list includes the called commands. In practice, most commands provided by the CAD application itself are often developed with the ObjectARX language. That is, each command developed with the ObjectARX language is either provided by the CAD application or developed by the user of the CAD application. In one embodiment, the automatic command statistic system 10 does not record statistics of a called command provided by the CAD application. If the determining module 124 determines the command list does not include the called command, that is the called command does not fall into the statistic pool, then the determining module 124 discards the called command. If the determining module 124 determines the command list includes the called command, that is the called command falls into the statistic pool, then the recording module 126 records the command run count and the calling associations of the called command.

In another embodiment, the determining module 124 is further configured for determining whether the called command developed with the LISP language has been called by the user of the CAD application or called by the CAD application itself. In one embodiment, the determining module 124 determines a length of the called command so as to determine whether the called command is called by the user of the CAD application or by the CAD application itself. Specifically, if a called command is longer than a predetermined value, then the determining module 124 determines the called command is called by the CAD application itself. If the called command is not longer than the predetermined value, then the determining module 124 determines that the user of the CAD application has called the command. If the determining module 124 determines the CAD application itself has called the command, that is the called command does not fall into the statistic pool, then the determining module 124 discards the called command.

The transforming module 128 is configured for transforming formats of the called command called by the user of the CAD application for recording statistics for commands developed with the LISP language. In practice, a command developed with the LISP language has different format compared to a command developed with the ObjectARX language. In one embodiment, each command developed with the LISP language and detected by the detecting module includes a special sign and a real name. The special sign may be “C:”, for example. Therefore, the transforming module 128 extracts the special sign and obtains the real names of the called command. In the embodiment, the recording module 126 records command run count and calling associations of the called command according to the real name obtained by the transforming module 128.

The uploading module 14 is configured for uploading the statistics of command run count and calling associations of all commands called by the user of the CAD application to a server 20. In one embodiment, the sever 20 communicates with a plurality of the automatic command statistic systems 10. As a result, the server 20 records statistics of all command run count and calling associations of the called commands uploaded from all the automatic command statistic systems 10.

The applying module 16 is configured for sorting all the called commands uploaded to the server 20 according to the command run count. In one embodiment, the applying module 16 sorts all the called commands in a descending order according to the command run count. As such, the applying module 16 obtains an order list of all the commands called by the user of the CAD application according to the command run count of the commands. Therefore, the applying module 16 can optimize commands of the CAD application or train beginners of the CAD application according to the order list of the called commands, for example.

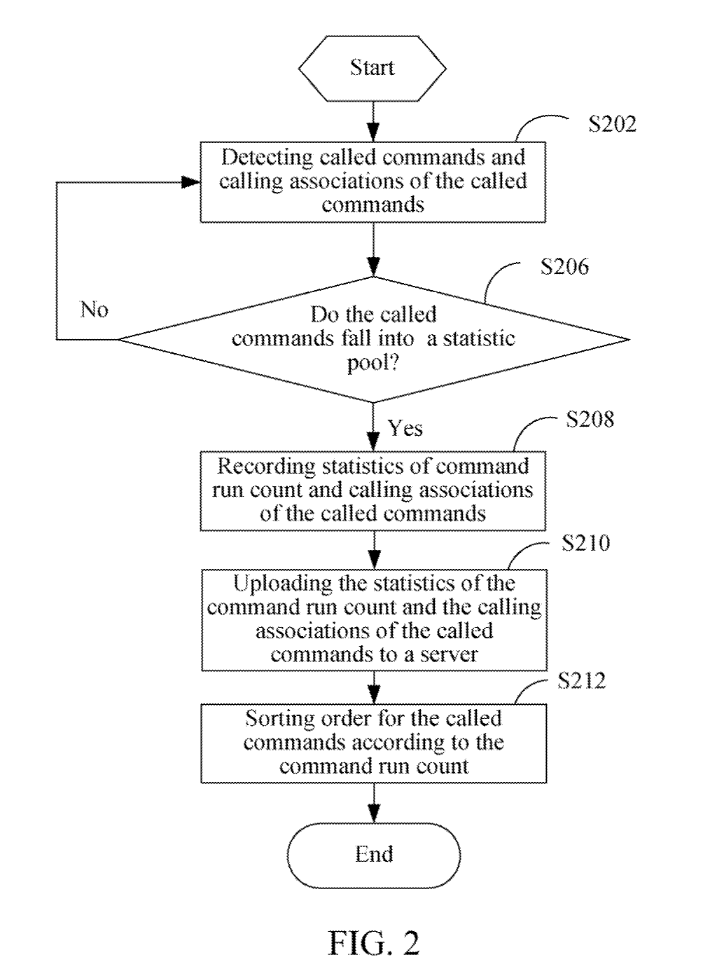

FIG. 2 is a flowchart of one embodiment of an automatic command statistic method in accordance with the present disclosure. In the embodiment of FIG. 2, the function modules depicted in FIG. 1 perform the automatic command statistic method. It may be understood that additional blocks may be added, others removed, and ordering of the blocks may be changed depending on the embodiment.

In block S202, the detecting module 122 detects a command called by a user of the CAD application and calling associations of the called command.

In block S206, the determining module 124 determines if the called command falls into a statistic pool. The statistic pool contains all commands that need to be recorded. For example, the called command detected by the detecting module 122 may be called by the user of the CAD application or be called by the CAD application itself. In one embodiment, the automatic command statistic system 10 only needs to record statistics of commands that have been called by the user of the CAD application. As a result, the statistic pool contains all commands called by the user of the CAD application.

If the called command does not fall into the statistic pool, then returning to block S202, the detecting module 122 continuously detects the command run count and the calling associations of other commands called by the user of the CAD application.

If the called command falls into the statistic pool, then in block S208, the recording module 126 records statistics of command run count and calling associations of the called command. In one embodiment, the block S200, S206, and S208 are periodically performed at the condition that the detecting module 122 detects a command called by a user of the CAD application. As such, the recording module 126 records statistics of all the command run count of commands called by the user of the CAD application.

In block S210, the uploading module 14 uploads the statistics of the command run count and the calling associations of all commands called by the user of the CAD application to the server 20. In one embodiment, the block S210 may be performed hourly or daily.

In block S212, the applying module 16 sorts the called commands uploaded to the server 20 according to the command run count. In one embodiment, the applying module 16 sorts the called commands in a descending order according to the command run count. As such, the applying module 16 obtains an order list of all the commands called by the user of the CAD application according to the command run count of the commands. Therefore, the applying module 16 can optimize commands of the CAD application or train beginners of the CAD application according to the order list of the called commands, for example.

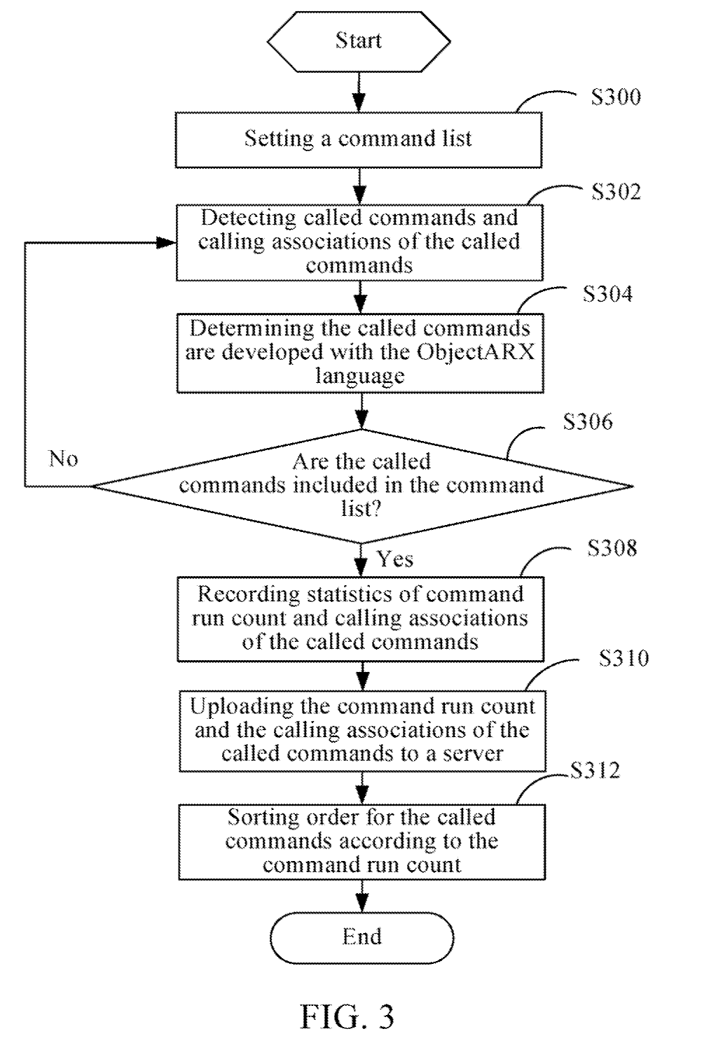

FIG. 3 is a detailed flowchart of the automatic command statistic method of FIG. 2. In the embodiment of FIG. 3, the automatic command statistic device 10 records one or more statistics regarding a command run count and calling associations of all commands called by a user of the CAD application. In one embodiment, the commands are developed with the ObjectARX language.

In block S300, the setting module 120 sets a command list. In one embodiment, the command list contains all commands developed by a user of the CAD application via its command customizing function. In one embodiment, the user of the CAD application may predetermine the command list.

The operations of block S302, block S310, and block S312 may be substantially the same as those of block S202, block S210, and block S212, respectively. Therefore, the detailed descriptions of block S302, block S310, and block S312 have been omitted.

In block S304, the determining module 124 determines that the called command has been developed with the ObjectARX language. In the embodiment of FIG. 3, the automatic command statistic system 10 does not record statistics of the called command provided by the CAD application itself.

In block S306, the determining module 124 determines if the command list includes the called command developed with the ObjectARX language. In one embodiment, if the command list includes the called command, then the called command falls into the statistic pool. If the command list does not include the called command, then the called command does not fall into the statistic pool.

If the command list does not include the called command, then returning to block S302, the detecting module 122 continuously detects other commands called by the user of the CAD application. In one embodiment, if the determining module 124 determines that the command list does not include the called command, that is the called command has been called by the CAD application itself, then the determining module 124 discards the called commands.

If the command list includes the called command, then in block S308, the recording module 126 records a command run count and calling associations of the called command. In one embodiment, the block S302 through block S308 are performed periodically. As such, the recording module 126 records all the called commands that have been developed by the user of the CAD application with the ObjectARX language.

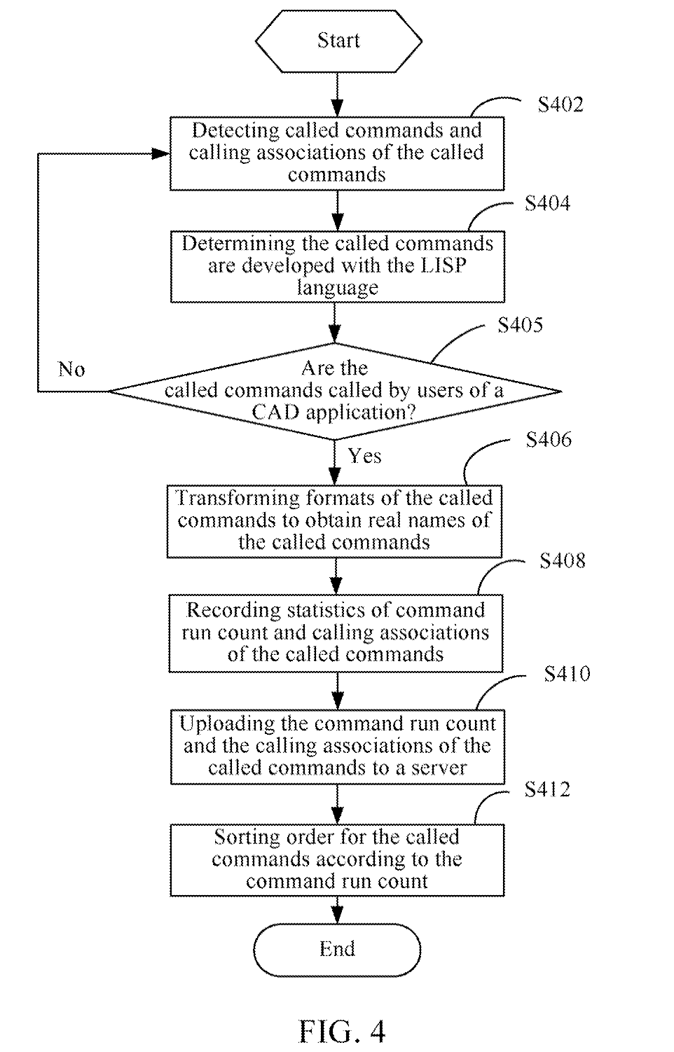

FIG. 4 is another detailed flowchart of the automatic command statistic method of FIG. 2. In the embodiment of FIG. 4, the automatic command statistic device 10 records statistic command run count and calling associations of commands called by a user of the CAD application. In one embodiment, the commands are developed with the LISP language.

The operations of block S402, block S410, and block S412 may be substantially the same as those of block S202, block S210, and block S212, respectively. Therefore the detailed descriptions of S402, block S410, and block S412 have been omitted.

In block S404, the determining module 124 determines that the called command has been developed with the LISP language.

If the called command has been developed with the LISP language, then in block S405, the determining module 124 determines whether the called command have been called by the user of the CAD application or called by the CAD application itself. In one embodiment, the determining module 124 determines a length of the called command so as to determine whether the called command is called by the user of the CAD application or called by the CAD application itself. Specifically, if the called command is longer than a predetermined value, then the determining module 124 determines that the called command has been called by the CAD application itself. If the called command is not longer than the predetermined value, then the determining module 124 determines that the user of the CAD application called the called command.

If the CAD application itself has called the called command, then returning to block S302, the detecting module 122 continuously detects the command run count and the calling associations of other commands called by the user of the CAD application. In one embodiment, if the determining module 124 determines that the CAD application itself has called the called command developed with the LISP application, then the determining module 124 discards the called command.

If the called command has been called by the user of the CAD application, then in block S406, the transforming module 128 transforms format of the called command if the called command has been called by the user of the CAD application, which is for recording statistics of calling run count and calling associations of the called command. In practice, a called command developed with the LISP language has different format compared to a called command developed with the ObjectARX language. In one embodiment, each called command developed with the LISP language and detected by the detecting module includes a special sign and a real name. The special sign may be “C:,” for example. Therefore, the transforming module 128 extracts the special sign so as to obtain the real name of the called command.

In block S408, the recording module 126 records the command run count and the calling associations of the called command according to the real name obtained by the transforming module 128. In one embodiment, the block S402 through block S408 are performed periodically. As such, the recording module 126 records all commands called by the user of the CAD application and developed with the LISP application.

The automatic command statistic system 10 of the present disclosure can automatically record statistics of command run count and calling associations of the called commands of a large application. The server 20, connected with a plurality of the automatic command statistic systems 10, sorts the called commands in a descending order according to the command run count from the plurality of the automatic command statistic systems 10, thereby ensuring authenticity of the statistics and allowing it to be in a wider range. The automatic command statistic system 10 of the present disclosure can improve statistic efficiency through classifying the called commands to different types according to development tools.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An automatic command statistic system, comprising:
a detecting module configured for detecting a command called by a user of an application and one or more calling associations of the called command;
a determining module configured for determining if the called command falls into a statistic pool that contains all commands of the application that need to be recorded; and
a recording module configured for recording one or more statistics regarding a command run count and calling associations of the called command falling into the statistic pool.

2. The automatic command statistic system as claimed in claim 1, wherein the determining module is further configured for determining whether the called command has been developed with the ObjectARX language or with the list processor (LISP) language by the user of a computer aided design (CAD) application.

3. The automatic command statistic system as claimed in claim 2, further comprising a setting module configured for setting a command list comprising all commands that have been developed by the user of the CAD application.

4. The automatic command statistic system as claimed in claim 3, wherein the determining module is further configured for determining if the command list comprises the called command developed with the ObjectARX language by the user of the CAD application.

5. The automatic command statistic system as claimed in claim 4, wherein the recording module is further configured for recording one or more statistics regarding the command run count and the calling associations of the called command included in the command list.

6. The automatic command statistic system as claimed in claim 2, wherein the called command developed with the LISP language and detected by the detecting module comprises a special sign and a real name.

7. The automatic command statistic system as claimed in claim 6, wherein the determining module is further configured for determining whether the called command developed with the LISP language has been called by the user of the CAD application or called by the CAD application itself.

8. The automatic command statistic system as claimed in claim 7, further comprising a transforming module configured for extracting the special sign of the called command called by the user of the CAD application so as to obtain the real name of the called command.

9. The automatic command statistic system as claimed in claim 8, wherein the recording module is further configured for recording statistic of the command run count and the calling associations of the called command according to the real name obtained by the transforming module.

10. The automatic command statistic system as claimed in claim 1, further comprising:
an uploading module configured for uploading the statistics of the command run count and the calling associations of all commands called by the user of the application to a server; and
an applying module configured for sorting all the called commands according to the command run count of the called commands.

11. An automatic command statistic method, comprising:
detecting a command called by a user of an application and one or more calling associations of the called command;
determining if the called command falls into a statistic pool comprising all commands of the application which need to be recorded; and
recording one or more statistic regarding a command run count and the calling associations of the called command that falls into the statistic pool.

12. The automatic command statistic method as claimed in claim 11, further comprising:
determining whether the called command has been developed with the ObjectARX language or with the list processor (LISP) language by the user of a computer aided design (CAD) application.

13. The automatic command statistic method as claimed in claim 12, further comprising:
setting a command list comprising all commands that have been developed by the user of the CAD application;
determining if the called command has been developed with the ObjectARX language;
determining if the command list comprises the called command if the called command has been developed with the ObjectARX language; and
recording statistics of the command run count and the calling associations of the called commands if the command list comprises the called command.

14. The automatic command statistic method as claimed in claim 12, wherein the called command developed with the LISP language comprises a special sign and a real name.

15. The automatic command statistic method as claimed in claim 14, further comprising:
determining if the called command has been developed with the LISP language;
determining whether the called command has been called by user of the CAD application or called by the CAD application itself if the called command has been developed with the LISP language;
extracting the special sign of the called command so as to obtain the real name of the called command if the called command has been called by the user of the CAD application; and
recording statistic of the command run count and the calling associations according to the real name of the called command.

16. The automatic command statistic method as claimed in claim 11, further comprising:
uploading the statistics of the command run count and the one or more calling associations of all commands called by the user of the application to a server; and sorting all the called commands according to the command run count of the called commands.
